(19) United States
(12) Patent Application Publication
(10) Pub. No.: US 2005/0231070 A1
(43) Pub. Date: Oct. 20, 2005

(54) Liquid metal processing and dispensing for liquid metal devices

(76) Inventor: Ronald Shane Fazzio, Loveland, CO (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/826,249

(22) Filed: Apr. 16, 2004

(51) Int. Cl. H02N 2/00

(52) U.S. Cl. 310/328

(57) ABSTRACT

A method is provided for manufacturing a liquid metal device. Liquid metal is solidified into solid metal balls. The solid metal balls are collected adjacent an opening in the liquid metal device. The solid metal balls are liquefied into liquid metal to flow into the opening.

### BACKGROUND

A reed relay is a typical example of a conventional small, mechanical contact type of electrical switch device. A reed relay has two reeds made of a magnetic alloy sealed in an inert gas inside a glass vessel surrounded by an electromagnetic driver coil. When current is not flowing in the coil, the tips of the reeds are biased to break contact and the device is switched off. When current is flowing in the coil, the tips of the reeds attract each other to make contact and the device is switched on.

The reed relay has problems related to its large size and relatively short service life. As to the first problem, the reeds not only require a relatively large space, but also do not perform well during high frequency switching due to their size and electromagnetic response. As to the second problem, the flexing of the reeds due to biasing and attraction causes mechanical fatigue, which can lead to breakage of the reeds after extended use.

In the past, the reeds were tipped with contacts composed of rhodium (Rh) or tungsten (W), or were plated with rhodium (Rh) or gold (Au) for conductivity and electrical arcing resistance when making and breaking contact between the reeds. However, these contacts would fail over time. This problem with the contacts has been improved with one type of reed relay called a “wet” relay. In a wet relay, a liquid metal, such as mercury (Hg) is used to make the contact. This solved the problem of contact failure, but the problem of mechanical fatigue of the reeds remained unsolved.

In an effort to solve these problems, electrical switch devices have been proposed that make use of the liquid metal in a channel between two switch electrodes. In the liquid metal devices, the liquid metal acts as the contact connecting the two switch electrodes when the device is switched ON. The liquid metal is separated between the two switch electrodes by a fluid non-conductor when the device is switched OFF. The fluid non-conductor fluid is generally high purity nitrogen (N) or another such inert gas.

With regard to the size problem, the liquid metal devices afford a reduction in the size of an electrical switch device since reeds are not required. Also, the use of the liquid metal affords longer service life and higher reliability. However, as device sizes have been reduced, it has become more and more difficult to provide the proper amounts of the liquid metal into the main channels where the liquid metal may be separated by the application of pressurized non-conductor fluid.

Solutions to these problems have been long sought but have long eluded those skilled in the art.

### SUMMARY OF THE INVENTION

The present invention provides a method for manufacturing a liquid metal device. Liquid metal is solidified into solid metal balls. The solid metal balls are collected adjacent an opening in the liquid metal device. The solid metal balls are liquefied into liquid metal to flow into the opening. This results in a simple and inexpensive liquid metal forming system and a dispensing system for manufacturing a liquid metal device having a compact and relatively simple structure, but also has high operating reliability and a long service life.

Certain embodiments of the invention have other advantages in addition to or in place of those mentioned above. The advantages will become apparent from a reading of the following detailed description when taken with reference to the accompanying drawings.

### BRIEF DESCRIPTION OF THE DRAWINGS

FIG. 1 is a cut away side view of a temperature-controlled chamber;

FIG. 2A is a cut away side view of an alternative embodiment of a temperature-controlled chamber;

FIG. 2B is a plan view of a top view of a tray with an array;

FIG. 3 is a cut away side view of a temperature-controlled agitator chamber;

FIG. 4 is a simplified cross-sectional close-up view of a portion of a liquid metal device in an intermediate stage of manufacture in accordance with one embodiment of the present invention;

FIG. 5 is the structure of FIG. 4 after formation of a liquid metal dispense reservoir;

FIG. 6 is the structure of FIG. 5 with solid metal balls shaken into the liquid metal dispense reservoir;

FIG. 7 is the structure of FIG. 6 after liquefaction of the solid metal balls and flow of liquid metal into the liquid metal device;

FIG. 8 is the structure of FIG. 7 after deposition of a sealing agent;

FIG. 9 is a simplified cross-sectional close-up view of a portion of a liquid metal device in an intermediate stage of manufacture in accordance with another embodiment of the present invention;

FIG. 10 is the structure of FIG. 9 after sealing by wafer bonding;

FIG. 11 is the liquid metal device according to an embodiment of the present invention; and

FIG. 12 is a flow chart 1200 of a method of manufacturing a liquid metal device in accordance with an embodiment of the present invention.

### DETAILED DESCRIPTION OF THE INVENTION

In the following description, numerous specific details are given to provide a thorough understanding of the invention. However, it will apparent that the invention may be practiced without these specific details. In order to avoid obscuring the present invention, some well-known system configurations and process steps are not disclosed in detail.

The term “horizontal” as used herein is defined as a plane parallel to the conventional plane or surface of the first substrate, regardless of its orientation. The term “vertical” refers to a direction perpendicular to the horizontal as just defined. Terms, such as “on”, “above”, “below”, “bottom”, “top”, “over”, and “under”, are defined with respect to the horizontal plane.

Likewise, the drawings showing embodiments of the invention are semi-diagrammatic and not to scale and, particularly, some of the dimensions are for the clarity of presentation and are shown greatly exaggerated in the FIGs. In addition, where multiple embodiments are disclosed and described having some features in common, for clarity and ease of illustration and description thereof like features one to another will ordinarily be described with like reference numerals.

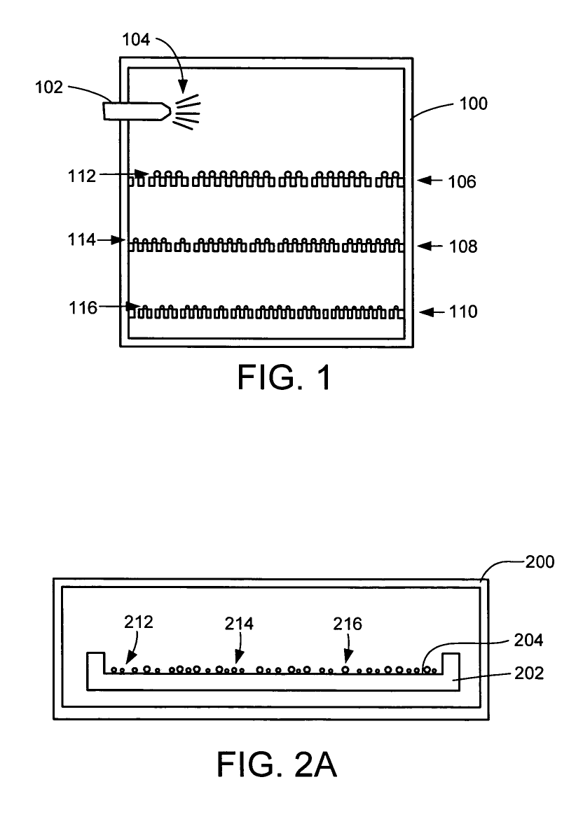

Referring now to FIG. 1, therein is shown a cut away side view of a temperature-controlled chamber 100. The temperature-controlled chamber 100 has a spray nozzle 102 for spraying a liquid metal 104 in liquid form into the chamber 100. Surface tension causes the liquid metal 104 to form into spheres or balls, and the temperature of the chamber 100 and the distance of the spray are controlled to cool the liquid metal 104 to form solid metal balls.

The temperature-controlled chamber 100 is provided with a number of screens having different size openings. For example, first, second, and third screens 106, 108, and 110 are shown, with the first screen 106 having the largest openings and the third screen 110 having the smallest openings.

In operation, the temperature-controlled chamber 100 is stabilized at temperatures less than that of the melting point of the liquid metal used, which may be a liquid metal such as mercury (Hg), alloys of gallium (Ga), etc. For example, for mercury the solidification temperature is −38° C.

The spray nozzle 102 will provide the liquid metal 104 as fine droplets, which will solidify in the less-than-melting point temperature of the temperature-controlled chamber 100. The fine droplets will form solid metal balls having a small range of sizes.

The solid metal balls will fall on the first, second and third screens 106, 108, and 110 in the temperature-controlled chamber 100.

Each screen has holes or openings that decrease in size from the top screen 106 down to the bottom screen 110. This means the solid metal balls isolated on a given screen will have a range of cross-sectional areas from smaller than the cross-sectional area of the holes in the screen above to larger than the cross-sectional area of the holes in the screen below. Also, the solid metal balls will have the same approximate volumes within each range of cross-sectional areas.

The first screen 106 will hold the largest solid metal balls 112, and the second and third screens, 108 and 110, will hold smaller solid metal balls 114 and 116 respectively. This screening process separates the solid metal balls into different size ranges. It will be understood that the number of screens is optional depending upon the size ranges of solid metal balls desired. Different size ranges of solid metal balls can be used in a single device for such purposes as filling vias in addition to filling channels and other openings.

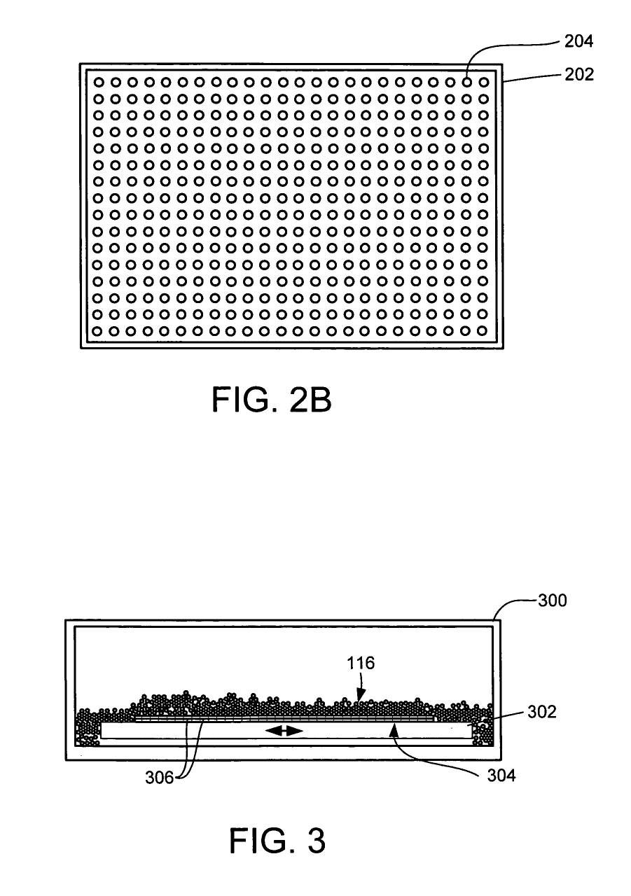

Referring now to FIGS. 2A and 2B, therein is shown in FIG. 2A a cut away side view of an alternative embodiment of a temperature-controlled chamber 200 shown in FIG. 2A. The temperature-controlled chamber 200 contains a tray 202 shown in plan view in FIG. 2B having an array of metalization or combination of metalization and tray/metalization features 204, such as small spots or etched material features, on the bottom that are energetically favorable for assisting the liquid metal to form balls on cooling. For example, for mercury, the array of metalization or combination of metalization and tray features 204 may use materials such as platinum (Pt) group metals such as ruthenium, rhodium, palladium, osmium, iridium, platinum, or a combination thereof.

The array of metalization 204 in an alternate embodiment could be a combination energetically favorable material as a base with a capture material cap. For example, the array of metalization or combination of metalization and tray features 204 could comprise a non-wettable etched feature in the tray and gold caps. The gold cap would “capture” a liquid metal such as mercury. The mercury would dissolve the gold and the etched feature would trap the mercury/gold amalgam assisting in ball formation.

The tray 202 is placed into the chamber 200. With the temperature lowered to less than the melting point of the liquid metal, e.g., −38° C. for mercury (Hg), the surface tension of the liquid metal will increase with decreasing temperature to form liquid metal balls, which then solidify to form solid metal balls 212, 214, and 216. The solid metal balls 212, 214, and 216 will have substantially similar volumes. However, the solid metal balls 212, 214, and 216 can subsequently be separated into even more uniform size ranges by being poured through the first, second and third screens 106, 108, and 110 of FIG. 1.

Referring now to FIG. 3, therein is shown a cut away side view of a temperature-controlled agitator chamber 300 having a mechanically agitated stage 302.

A wafer 304 containing empty liquid metal devices 306, such as micro electric switches, formed in and on device substrates is placed on the mechanically agitated stage 302. The temperature-controlled agitator chamber 300 is kept chilled below the solidification temperature of the solid metal balls.

Layers of solid metal balls, such as the solid metal balls 116 (FIG. 1) or 212 (FIG. 2) are then placed on top of the wafer 304. The wafer 304 is then agitated by a method such as vibration or reciprocation so that the small grooves or other etched features will trap the solid metal balls 116 or 212.

Small grooves or other etched openings (such as a liquid metal dispense reservoir 500 shown in FIG. 5) in the wafer 304 are placed upward so as to capture solid metal balls. The size range and number of solid metal balls in the liquid metal dispense reservoirs will be determined by the device layout. Size (along with device layout) can be used as a control parameter to insure that the correct number of solid metal balls is placed in each of the liquid metal dispense reservoirs. This permits control of the amount of liquid metal provided in each opening or channel in the wafer 304.

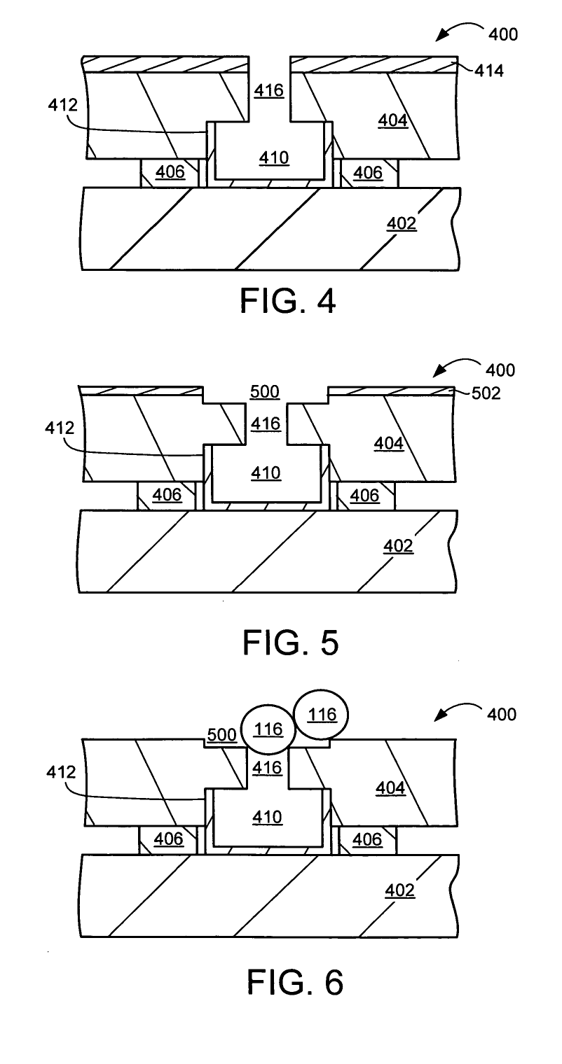

The wafer 304 with the trapped solid metal balls 116 or 212 is removed from the temperature-controlled agitator chamber 300. Each of the empty liquid metal devices 306 has a main chamber (such as the main chamber 410 of FIG. 4) to be at least partially filled with liquid metal. The main chamber is connected to the small groove or other etched feature on the top of the wafer 304.

The solid metal balls 116 or 212 are then allowed to liquefy or are melted into the liquid metal by being allowed to return to ambient temperature or being heated. This melting causes the liquid metal to flow into the main chambers of the liquid metal devices 306.

It will be understood that there are variations, which include using different wettable agents, surfactants, and/or pressure differentials to draw the liquid metal into the main channel of the liquid metal devices 306; e.g., depositing gold (Au) or some other wettable agent into the grooves or other etched features, or putting the wafer 304 into a pressure vessel while heating.

After the liquid metal is dispensed, then the main channel is sealed by a sealing agent and the substrates bonded by an adhesive; e.g., an adhesive sealing material may be a material such as one of the Cytop® materials (a registered trademark of Asahi Glass Company, available from Bellex International Corp. of Wilmington, Del.), spin-on-glass, epoxy, metal, or other material acting as a bonding agent and providing a hermetic seal.

Referring now to FIG. 4, therein is shown a simplified cross-sectional close-up view of a portion of an exemplary liquid metal device 400 in an intermediate stage of manufacture in accordance with one embodiment of the present invention. The liquid metal device 400 has a first substrate 402 bonded to a second substrate 404 by adhesive seals 406. The first and second substrates 402 and 404 are impervious to liquid metal and the adhesive seals 406 are impervious to liquid metal.

The adhesive seals 406 can be of a material such as gold protected by a glass layer, which provides a seal which is impervious to mercury and which bonds well to silicon substrates. When gold is used for the wafer bond with silicon wafers, a seed layer is used between the gold and the silicon in order to make sure that the gold adheres to the silicon. A main channel 410 has been formed in the second substrate 404, which contains an inner seal 412. The inner seal 412 can be of a material such as glass. The inner seal 412 will only be around the main channel 410.

A liquid metal dispense channel mask 414 has been deposited on top of the second substrate 404 and processed to allow the formation of a groove or other etched feature. In this embodiment, the etching forms an opening to the main channel 410 referred to as a liquid metal dispense channel 416.

Referring now to FIG. 5, therein is shown the structure of FIG. 4 after formation of a liquid metal dispense reservoir 500. The liquid metal dispense channel mask 414 of FIG. 4 is removed and a liquid metal dispense reservoir mask 502 is deposited and processed for the formation of the liquid metal dispense reservoir 500. The liquid metal dispense reservoir 500 is optional where the liquid metal dispense channel 416 is sufficiently large. However, in many instances, the liquid metal dispense reservoir 500 is required to allow solid metal to be collected therein.

Referring now to FIG. 6, therein are shown small-size range solid metal balls 116 shaken onto the structure of FIG. 5 to be captured by the liquid metal dispense reservoir 500. The liquid metal dispense reservoir mask 502 of FIG. 5 has been removed.

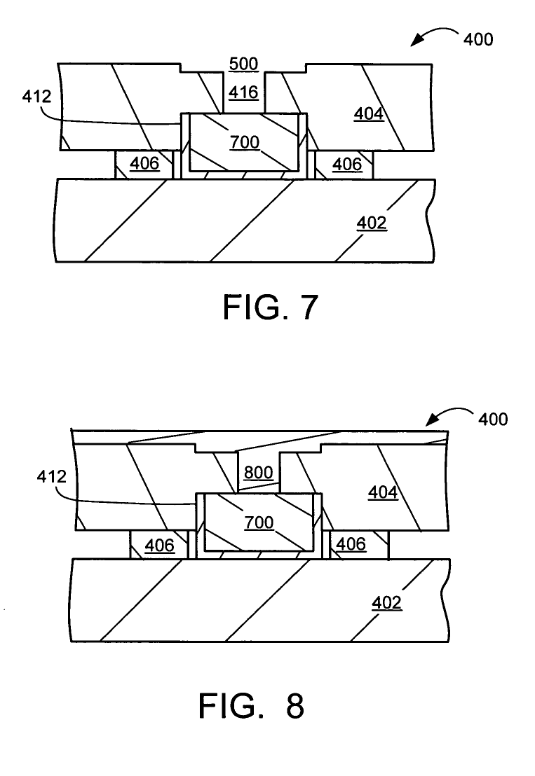

Referring now to FIG. 7, therein is shown the structure of FIG. 6 after liquefaction of the small-size range solid metal balls 116 and flow of liquid metal 700 into the main chamber 410 (shown in FIG. 4) of the liquid metal device 400. The liquid metal device 400 can be brought up to room temperature or a liquid metal flow bake performed to cause the small-size range solid metal balls 116 of FIG. 6 to melt and flow to at least partially fill the main channel 410.

Referring now to FIG. 8, therein is shown the structure of FIG. 7 after deposition of a sealing agent 800. The sealing agent 800 at least partially fills the liquid metal dispense channel 416 and the liquid metal dispense reservoir 500 of FIG. 5 to completely seal off the liquid metal 700.

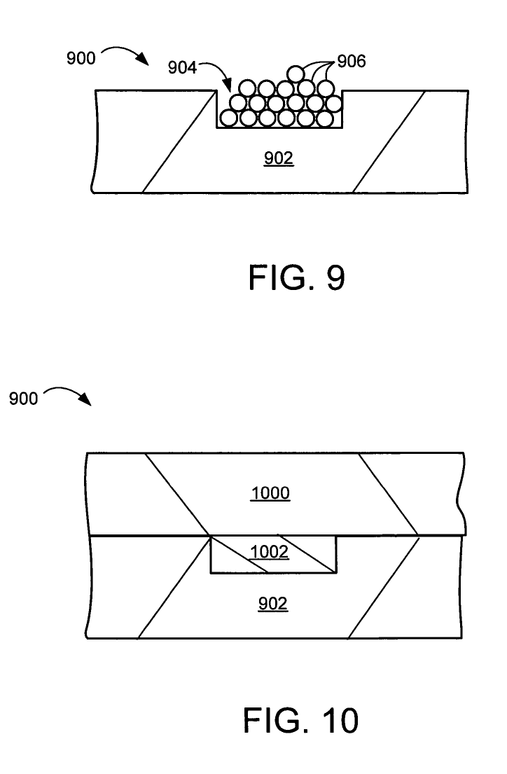

Referring now to FIG. 9, therein is shown a simplified cross-sectional close-up view of a portion of an exemplary liquid metal device 900 in an intermediate stage of manufacture in accordance with another embodiment of the present invention. The liquid metal device 900 has a first substrate 902. A main channel 904 has been formed in the first substrate 902, and small-size range solid metal balls 906 shaken onto first substrate 902 to be captured by the main channel 904.

Referring now to FIG. 10, therein is shown the structure of FIG. 9 after the main channel 904 is sealed by bonding a second substrate 1000 to the first substrate 402. A sealing material is optional in this case. This bonding would be a wafer bond where the two wafers are clean of particles and placed in contact for low temperature bonding by annealing, solder, or thermocompression bonding. Wafer bonding may optionally utilize an adhesive seal like the adhesive seal 406 shown in FIG. 4. The first and second substrates 902 and 1000, and the wafer bond are impervious to the liquid metal. The small-size range solid metal balls 906 are then melted into the liquid metal 1002.

The liquid metal device 900 is not necessarily preferable to the liquid metal device 400 of FIG. 8, since liquid metals have relatively low boiling points. This implies that any wafer bond process to seal the liquid metals is most conveniently a low temperature process. When using mercury, dispensing the mercury before a wafer bond process also means that wafers with liquid mercury on the surface need to be handled carefully in the manufacturing environment for subsequent processing because mercury is a toxic substance.

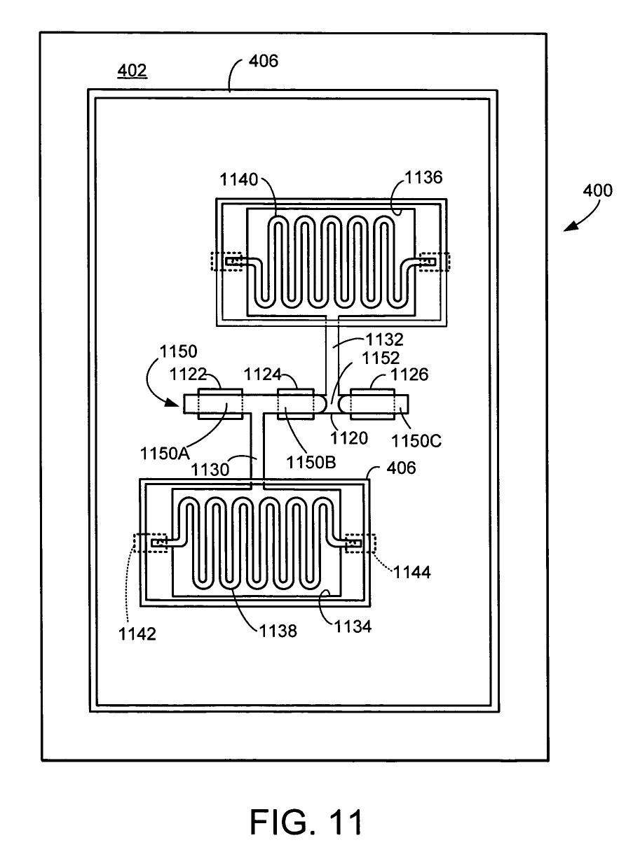

Referring now to FIG. 11, therein is shown the liquid metal device 400 according to an embodiment of the present invention. For ease of understanding, the top substrate is not shown. A single throw switch device with two electrodes and a single heater unit is the simplest configuration, but a more complex embodiment of a double throw switch device having three electrodes and two heater units is shown. The liquid metal device 400 has the first substrate 402 and adhesive seals 406.

While different elements of the present invention can be on different substrates, the first substrate 402 is shown as including a main channel 1120, and three electrodes 1122, 1124, and 1126 are deposited in spaced relationship along the length of the main channel 1120.

Sub-channels 1130 and 1132 are also formed in the first substrate 402 respectively connected to the main channel 1120 between the electrodes 1122 and 1124 and between the electrodes 1124 and 1126. The sub-channels 1130 and 1132 respectively connect to chambers 1134 and 1136, which are formed in the substrate 402. The chambers 1134 and 1136 respectively are under heating elements 1138 and 1140.

The heating elements 1138 and 1140 in one embodiment are resistive heating elements electrically powered through the vias 1142 and 1144 through the first substrate 402. The filled vias are perpendicular holes through the first substrate 402 that are filled with a conductor so there are no significant leaks through the holes.

The first substrate 402 has the main channel 1120 filled with a liquid metal 1150, such as mercury (Hg), and a fluid non-conductor 1152, such as argon (Ar) or nitrogen (N). The second substrate 404 of FIG. 4 overlays the first substrate 402, and the liquid metal 1150 and the fluid non-conductor 1152 are sealed in the main channel 1120, the sub-channels 1130 and 1132, and the chambers 1134 and 1136 by the adhesive seals 406. The fluid non-conductor 1152 is capable of being expanded by the heating elements 1138 and 1140 to cause divisions in the liquid metal 1150.

The materials of the first and second substrates 402 and 404 and of the adhesive seals 406 are selected to avoid chemical reaction with and wetting by the liquid metal 1150. Chemical reactions may render the liquid metal 1150 incapable of conducting current and wetting may make proper switching movement of the liquid metal 1150 impossible; i.e., an OFF state cannot be achieved because the electrical path between the electrodes 1122, 1124, and 1126 cannot be interrupted. Chemical reactions and wetting of the substrates or seals can also lead to leakage currents and reliability failures.

In operation, the liquid metal 1150 can be divided into first, second and third portions 1150A, 1150B, and 1150C, which are always respectively connected to the electrodes 1122, 1124, and 1126. The sub-channels 1130 and 1132, the chambers 1134 and 1136, and portions of the main channel 1120 are filled with the fluid non-conductor 1152. The fluid non-conductor 1152 is capable of separating the liquid metal 1150 into discrete portions, which will either connect the electrodes 1122 and 1124 or the electrodes 1124 and 1126 depending on whether the heating element 1140 or the heating element 1138 is respectively actuated.

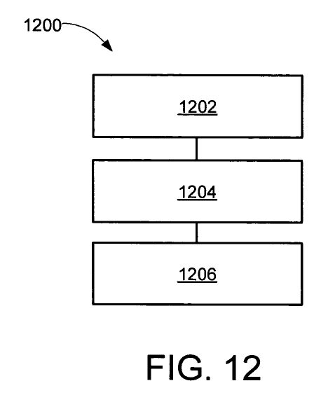

Referring now to FIG. 12, therein is shown a flow chart 1200 of the method of manufacturing a liquid metal device in accordance with the present invention. The method includes: solidifying liquid metal into solid metal balls in a block 1202; collecting the solid metal balls adjacent an opening in the liquid metal device in a block 1204; and liquefying the solid metal balls into liquid metal to flow into the opening in a block 1206.

While the invention has been described in conjunction with specific embodiments, it is to be understood that many alternatives, modifications, and variations will be apparent in the art in light of the aforegoing description. Accordingly, it is intended to embrace all such alternatives, modifications, and variations that fall within the scope of the included claims. All matters hithertofore set forth or shown in the accompanying drawings are to be interpreted in an illustrative and non-limiting sense.

1. A method for manufacturing a liquid metal device, the method comprising:
solidifying liquid metal into solid metal balls;
collecting the solid metal balls adjacent an opening in the liquid metal device; and
liquefying the solid metal balls into liquid metal to flow into the opening.

2. The method of claim 1 wherein:
solidifying the liquid metal includes spraying the liquid metal in a liquid state into a temperature-controlled chamber to form into the solid metal balls.

3. The method of claim 1 wherein:
solidifying the liquid metal includes collecting the liquid metal on a material that assists in ball formation in a temperature-controlled chamber to form into the solid metal balls.

4. The method of claim 1 wherein:
solidifying the liquid metal includes collecting the liquid metal on an array of material or a material and a material feature that assists in ball formation in a temperature-controlled chamber to form into the solid metal balls.

5. The method of claim 1 additionally comprising:
separating the solid metal balls into different size ranges; and
collecting the solid metal balls adjacent to the opening places solid metal balls of one size range adjacent to the opening.

6. The method of claim 1 additionally comprising:
forming the liquid metal device to have a liquid metal dispensing reservoir adjacent the opening to trap the solid metal balls adjacent to the opening.

7. The method of claim 1 additionally comprising:
agitating the solid metal balls to fill a liquid metal dispensing reservoir adjacent to the opening.

8. A method for manufacturing a liquid metal switch device, the method comprising:
solidifying liquid metal into solid metal balls;
separating the solid metal balls into different size ranges;
collecting the solid metal balls of one size range adjacent an opening in the liquid metal device; and
liquefying the solid metal balls into liquid metal to flow into the opening.

9. The method of claim 8 wherein:
solidifying the liquid metal includes spraying the liquid metal in a liquid state into a temperature-controlled chamber to form into the solid metal balls.

10. The method of claim 8 wherein:
solidifying the liquid metal includes collecting the liquid metal on a material or a material and a material feature that assists in ball formation in a temperature-controlled chamber to form into the solid metal balls.

11. The method of claim 8 wherein:
solidifying the liquid metal includes collecting the liquid metal on an array of a material that assists in ball formation in a temperature-controlled chamber to form into the solid metal balls.

12. The method of claim 8 wherein:
separating the solid metal balls uses screens, the screens each having different size openings.

13. The method of claim 8 additionally comprising:
forming the liquid metal device to have a liquid metal dispensing reservoir adjacent the opening to trap the solid metal balls of at least one of the different size ranges adjacent the opening.

14. The method of claim 8 additionally comprising:
agitating the solid metal balls to fill a liquid metal dispensing reservoir coupled to the opening;
melting the solid metal balls;
using a wetting agent, a surfactant, or differential pressure, to fill a main chamber in the liquid metal device through the opening; and
sealing the liquid metal dispensing reservoir with liquid metal in the main chamber.

15. A liquid metal switch device manufacturing system comprising:
temperature-controlled equipment for solidifying liquid metal into solid metal balls;
screening equipment for separating the solid metal balls into different size ranges; and
a separator for collecting the solid metal balls of one size range adjacent an opening provided in the liquid metal device.

16. The system of claim 15 wherein:
the temperature-controlled equipment comprises a cooling chamber and a spray nozzle for spraying the liquid metal in a liquid state into the temperature-controlled chamber to form into the solid metal balls.

17. The system of claim 15 wherein:
the temperature-controlled equipment comprises:
a tray having an array of a material or a material and a tray feature that assists in ball formation of liquid metal; and
a temperature-controlled chamber to cool liquid metal placed onto the array into the solid metal balls.

18. The system of claim 15 wherein:
the separator comprises stacked screens, each screen having smaller size openings than the screen above.

19. The system of claim 15 wherein:
the liquid metal device has a liquid metal dispensing reservoir adjacent the opening to trap the solid metal balls of at least one of the different size ranges adjacent the opening.

20. The system of claim 15 additionally comprising:
an agitator for agitating the solid metal balls and the liquid metal switch device to fill a liquid metal dispensing reservoir provided therein;
means for melting the solid metal balls to fill a main chamber in the liquid metal device has the opening; and
a seal for sealing the liquid metal dispensing reservoir and the liquid metal in the main chamber.
